(19) United States
(12) Patent Application Publication
(10) Pub. No.: US 2024/0346245 A1
(43) Pub. Date: Oct. 17, 2024

(54) DEVICE AND METHOD FOR TRAINING A LANGUAGE MODEL

(71) Applicant: Garena Online Private Limited, Singapore (SG)

(72) Inventor: Qian LIU, Singapore (SG)

(21) Appl. No.: 18/634,828

(22) Filed: Apr. 12, 2024

(30) Foreign Application Priority Data
Apr. 14, 2023 (SG) 10202301040X
Apr. 11, 2024 (SG) 10202401057X

(51) Int. Cl. G06F 40/20; G06F 16/2452

(52) U.S. Cl. CPC G06F 40/20; G06F 16/24522

(57) ABSTRACT

System, methods, and non-transitory computer-readable medium are provided for training a language model. For example, a method may include generating training data. In some instances, the training data may include symbolic tasks and natural language tasks and target outputs associated with the symbolic tasks and the natural language tasks. Additionally, the method may include performing instruction tuning of a language model using the training data.

### CROSS REFERENCE TO RELATED APPLICATIONS

This patent application claims the benefit and priority of Provisional Singaporean Patent Application No. 10202301040X, filed with the Intellectual Property Office of Singapore on Apr. 14, 2023 and of Singaporean Patent Application No. 10202401057X, filed with the Intellectual Property Office of Singapore on Apr. 11, 2024, the contents of which are incorporated by reference in their entireties.

### TECHNICAL FIELD

Various aspects of this disclosure relate to devices and methods for training a language model.

### BACKGROUND

In recent years, the development of language models (LM) has been one of the most significant advances in natural language processing (NLP). After being trained on large amounts of natural language corpus with a language modeling objective, LMs have demonstrated impressive performance on a variety of NLP tasks. Furthermore, recent progress show that LMs are able to do zero-shot task generalization, which means they can adapt to unseen tasks without any specific fine-tuning on those tasks. Along this way, one promising direction is the instruction tuning. By fine-tuning LMs to follow instructions on diverse tasks, instruction tuning enables LMs to perform well on tasks they have not been trained on. Despite the popularity, most existing instruction tuning methods focus on crowd-sourced human tasks or model-generated tasks for instruction tuning, which are either in limited quantity or quality. As scaling up language models in different dimensions has shown promise in pushing the boundaries of zero-shot performance, the search for high-quality and scalable instruction tuning tasks has become increasingly important.

Accordingly, approaches that allow efficient fine-tuning of large-language models are desirable.

### SUMMARY

Various embodiments concern a method for training a language model, comprising generating training data which includes symbolic tasks and natural language tasks and target outputs for the symbolic tasks and the natural language tasks and performing instruction tuning (fine-tuning to follow instructions) of the language model using the generated training data.

According to one embodiment, the training data includes training inputs, wherein each training input includes a symbolic task and an instruction to perform the symbolic task or a natural language task and an instruction to perform the natural language task.

According to one embodiment, the method comprises determining a loss between outputs of the language model for the natural language tasks and the target outputs for the natural language tasks and adapting parameters of the language model to reduce the loss.

According to one embodiment, the method comprises determining a loss between outputs of the language model for the symbolic tasks and the target outputs for the symbolic tasks and adapting parameters of the language model to reduce the loss.

According to one embodiment, the language model comprises a neural network and the parameters include neural network weights.

According to one embodiment, each of at least some of the symbolic tasks is a query in a database query language.

According to one embodiment, the database query language is Structured Query Language.

According to one embodiment, the method comprises training the language model using a training data set which includes first training data elements each first training data element including a specification of a respective symbolic task and a target output (for loss calculation) for the symbolic task and which includes second training data elements each second training data element including a specification of a respective natural language task a target output (for loss calculation) for the natural language task.

According to one embodiment, the method comprises training the language model using a training data set which includes training data, each training data element including, as training input, a specification of a respective symbolic task, a target output for the symbolic task (as demonstration in the input) and a natural language task and including a target output (for loss calculation) for the natural language task.

According to one embodiment, the specification of the symbolic task includes a database table and the symbolic task is a query of the database table.

According to one embodiment, the language model is a large language model.

According to one embodiment, the language model is a pre-trained language model and the method comprises fine-tuning the pre-trained language model using the generated training data (e.g. for zero-shot generalization).

According to one embodiment, a data processing system is provided configured to perform the method of any one of the embodiments described above.

According to one embodiment, a computer program element is provided comprising program instructions, which, when executed by one or more processors, cause the one or more processors to perform the method of any one of the embodiments described above.

According to one embodiment, a computer-readable medium is provided comprising program instructions, which, when executed by one or more processors, cause the one or more processors to perform the method of any one of the embodiments described above.

### BRIEF DESCRIPTION OF THE DRAWINGS

The invention will be better understood with reference to the detailed description when considered in conjunction with the non-limiting examples and the accompanying drawings, in which:

FIG. 1 illustrates training and usage of a language model (LM).

FIG. 2 illustrates the fine-tuning of a language model using natural language tasks in combination of symbolic tasks.

FIG. 3 illustrates the generation of a symbolic task training element 301 from an SQL query and a random table.

FIG. 4 illustrates different instruction strategies to prompt a large LM, including zero-shot, synthetic demonstration and realistic demonstration.

FIG. 5 shows a flow diagram illustrating a method for training a language model.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

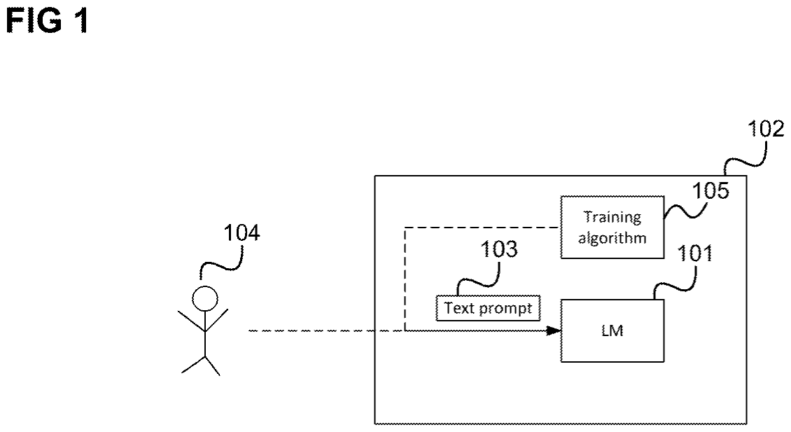

FIG. 1 illustrates training a usage of a language model (LM) 101, e.g. a large language model (LLM). The LM 101 is running on a computer 102 and receives a text prompt 103 as input. The text prompt 103 is typically input by a user 104 when the LM 101 is used but it may also be input in pre-training or fine-tuning of the LM 101 by a training algorithm 105 (which may run on the computer 102 itself). The communication with the user 104 may be via a keyboard of the computer but also via a communication network in case the user 104 uses the LM 101 remotely from a client device.

A language model 101 is typically pre-trained but may then be fine-tuned, in particular by instruction tuning. Fine-tuning language models on tasks with instructions has demonstrated potential in facilitating zero-shot generalization to unseen tasks. According to various embodiments, a straightforward yet effective method for enhancing instruction tuning by employing symbolic tasks is provided, i.e. symbolic tasks are used as a complementary training resource for instruction tuning. Compared to using crowd-sourced human tasks or model-generated tasks for fine-tuning, symbolic tasks present a unique advantage as they can be easily generated in vast quantities, theoretically providing an infinite supply of high-quality training instances. Empirical results on various benchmarks validate that the integration of SQL execution leads to significant improvements in zero-shot scenarios, particularly in table reasoning. Furthermore, experimental results reveal that language models can be enhanced through symbolic tasks without compromising their generality.

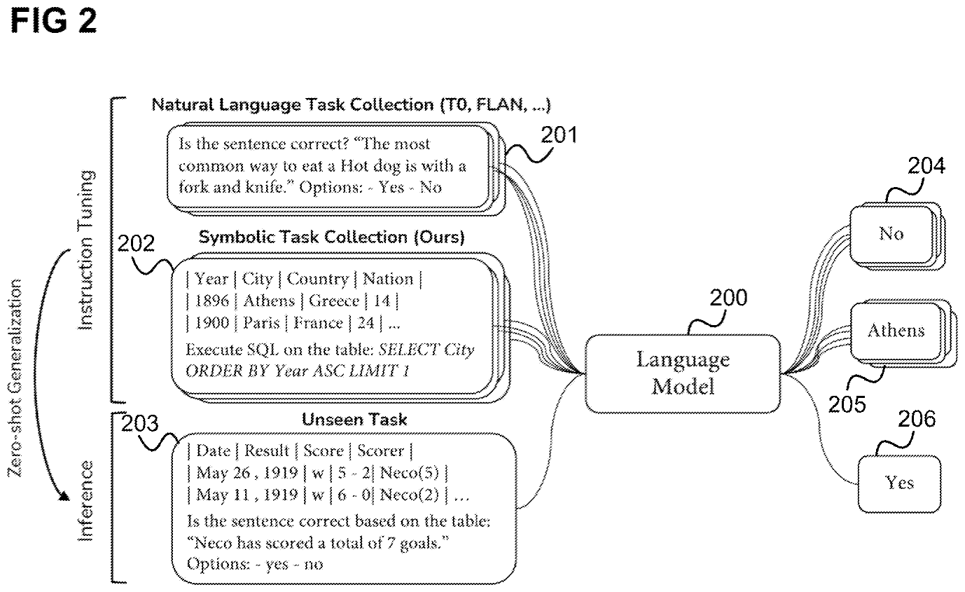

FIG. 2 illustrates the fine-tuning of a language model 200 using natural language tasks 201 (e.g. fact checking) in combination of symbolic tasks 202 (e.g., SQL execution), each being provided with a target response 204, 205 (i.e. ground truth information) for leaning or training, for example supervised training (e.g. by the training algorithm 105), to then be able to provide the correct answer 206 to an unseen tasks 203 (e.g. table fact verification.), e.g. provided by the user 104 or still by the training algorithm 105 for validation or testing. For supervised training, a loss (e.g. 12 loss) may be calculated using the target responses 204, 205. Other types of training or learning, such as unsupervised learning or semi-supervised learning may be contemplated.

A symbolic task is a form of problem-solving or computational process that entails the manipulation of symbolic representations or structured data (e.g., sorting a disordered array). In general, symbolic tasks are characterized by the use of symbols in formal systems, such as logic, mathematics, or programming languages (including database query languages), instead of relying on natural language. Unlike natural language, symbols in symbolic tasks follow a (pre-defined) limited set of grammatical rules, making them easier to synthesize systematically. So, in other words, symbolic tasks are formulated as expressions of symbols (from a set of predefined symbols including predefined key words etc.) according to a predefined set of syntax rules (e.g. of a predefined programming or query language) while natural language tasks are formulated in natural language (e.g. English language).

Symbols of symbolic tasks can quickly expand in scale through composition and can be executed on symbolic executors to yield the corresponding output. As a result, generating diverse, complex, and consistent examples for symbolic tasks is relatively easy compared to crowd-sourced human tasks or model-generated tasks. This case of generation theoretically allows for a large number of high-quality examples to be created for instruction tuning. Given the advantageous properties of symbolic tasks, symbolic tasks can serve as a strong complement as a source for instruction tuning: if a model trained with instruction tuning is capable of performing both symbolic tasks and natural language tasks, then the inherent abilities learned in symbolic tasks can be transferred to unseen natural language tasks.

SQL execution is herein used as a representative example of symbolic tasks in instruction tuning. SQL execution refers to the process of executing SQL statements to interact with tables. The interaction between SQL and tables can be extended to natural language (NL) based table reasoning without using any table reasoning example in the fine-tuning. Other examples for symbolic tasks include evaluating mathematical expressions involving numbers, operators (e.g., add), variables and functions (e.g., sin, cos, log) and executing code written in programming languages (e.g., Python), which involve symbolic representations of syntax, control structures, data types and operations.

Empirical results show that the incorporation of SQL execution yields substantial improvements across different benchmarks of table reasoning (zero-shot table reasoning). In addition to being used with training, symbolic tasks can also be leveraged by large language models (e.g., GPT-3) without training, as part of their instructions to boost their performance. For example, without any realistic example in WTQ (WikiTableQuestions), SQL execution can boost the GPT-3 performance significantly. Furthermore, the SQL execution task not only enhances performance on table reasoning but also leads to a significant improvement in mathematical reasoning performance. Further, experiments show that fine-tuning with symbolic tasks does not hurt the model performance on generic held-out tasks, implying that LMs can be improved through symbolic tasks without compromising their generality.

Since, as explained above, embodiments leverage symbolic tasks in instruction tuning, and since symbolic tasks are one typical case of synthetic tasks, some more details about instruction tuning and synthetic training are given in the following.

Instruction tuning is a popular direction in NLP (natural language processing) to enable zero-shot generalization on unseen tasks. The core idea behind instruction tuning is that LMs are fine-tuned to accomplish diverse tasks by following a set of instructions. Therefore, the task source becomes important in instruction tuning. Typically, existing publicly available datasets are collected for the training (specifically: fine-tuning), including T0, FLAN (Fine-tuned LAnguage Net) and NaturalInstructions, or carefully crowd-sourced diverse tasks with human annotations, including Super-NaturalInstructions and InstructGPT. While these mixtures of tasks are generally of high quality, they often rely on a significant amount of human effort and are usually limited in quantity, so symbolic tasks can be a valuable addition to address this quantity limitation.

An option is also to use model-generated tasks which invoke a large language model (e.g., GPT-3) to generate a diverse set of instructions, task inputs, and task outputs based on a high-quality seed set. However, these model-generated datasets not only rely on a powerful LLM, but also introduce a lot of noise (i.e., task output does not correspond to the task input) in the training data. In contrast, in symbolic tasks, it can be ensured that the task output corresponds to the task input because the output is automatically obtained from reliable symbolic executors.

Synthetic training is a technique that leverages synthetic tasks, whose examples can be synthesized automatically, to improve the model performance on downstream tasks.

Synthetic task usage can include attaining high natural language pre-training performance using artificial tasks, usage of SQL execution in (table) pre-training, the application of synchronous context-free grammars in text-to-SQL parsing, the use of synthetic data in numerical reasoning and the use of environment-adaptive synthetic data in language-based environment manipulation tasks.

According to various embodiments, as explained above, synthetic tasks are used for fine-tuning to enable zero-shot generalization on downstream tasks without any subsequent additional fine-tuning on the downstream tasks being necessary.

In the following, an example for the data synthesis for the SQL execution corpus (i.e. for the training data set of symbolic tasks 202, each with associated target output) is described and two ways to leverage the symbolic tasks 202 in instruction tuning are described: multi-task fine-tuning and synthetic demonstrations. The multi-task fine-tuning method is a training-involved use case of the symbolic tasks 202, where the LM 200 is jointly trained on the symbolic task 202 and the NL tasks 201. The synthetic demonstration method is a training-free use case, where the symbolic tasks 202 are synthesized and each inserted into an NL instruction (i.e. in an NL task 201), and then fed into the LM 200.

According to one embodiment, SQL execution is used as (e.g. the only) symbolic task. Therefore, the most important factors for the data synthesis are the table source and the SQL queries. The SQL queries (i.e. training (input) instances for SQL execution of symbolic tasks) is for example synthesized by using SQL templates, e.g. from the SQUALL (SQL+QUestion pairs ALigned Lexically) dataset.

For instance, a typical SQL template might look like SELECT num1 WHERE text1=val1, with num1 representing a numeric column and text1 a text column, while val1 corresponds to a specific cell value related to the text1 column. To create concrete SQL queries, headers and cell values from a given table are for example randomly chosen to populate the template. By instantiating SQL templates on the table source, high-quality examples can be synthesized at any scale.

Given an executable SQL query and a table T, where T consists of M rows {rᵢ}ᵢ₌₁^{M} and N headers {cⱼ}ⱼ₌₁^{N} the table is first flattened into a sequence T*, and then concatenated with the SQL query and the task instruction to create training examples.

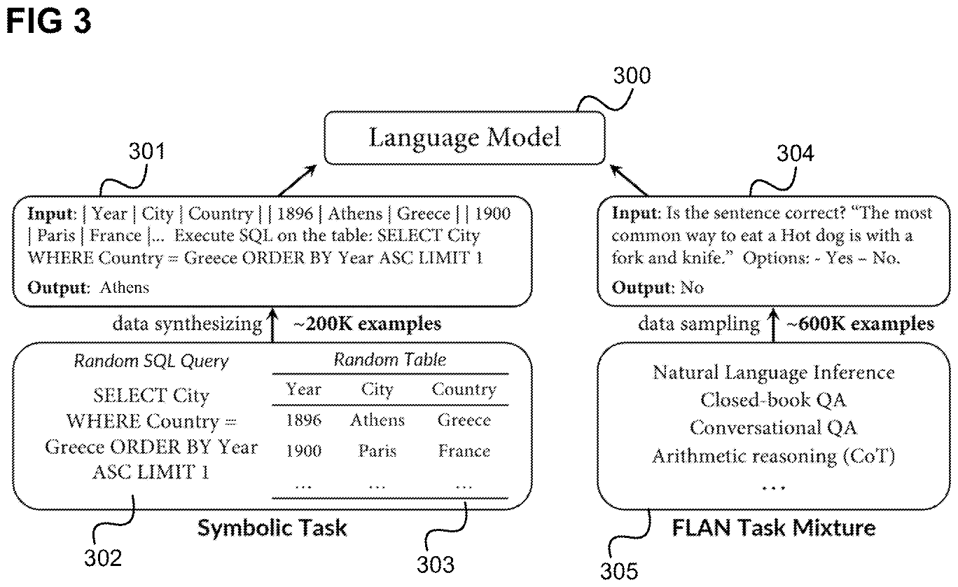

FIG. 3 illustrates the generation of a symbolic task training element 301 from a (random) SQL query 302 and a random table 303.

The task instruction is “Execute SQL on the table” and the training input of the symbolic task training element 301 is “|Year|City|Country| |1896|Athens|Greece| |1900|Paris|France| . . . Execute SQL on the table: SELECT City WHERE Country=Greece ORDER BY Year ASC LIMIT 1”. The target output of the symbolic task training element 301 is the execution result of the SQL query “Athens”, which can be obtained by running the SQL query through an off-the-shelf SQL executor, such as MySQL.

It should be noted that the task instruction is “Execute SQL on the table” for all symbolic task training elements 301. In practice, to obtain the flattened table T* without losing the table structure information, various special tokens can be included to indicate the boundaries inside the table. Denoting a flattened table as T*=[HEAD], c₁, . . . , C_{N}, [ROW], 1, r₁, [ROW], 2, r₂, . . . , r_{M}, the special tokens [HEAD] and [ROW] represent the table header and rows respectively. Additionally, the number following [ROW] indicates the row index.

In the instruction tuning paradigm, multi-task fine-tuning may play an important role, especially in the diversity of tasks. A straightforward approach to leverage the symbolic task is to incorporate it as part of the fine-tuning tasks, with diverse examples. To make the tasks more diverse, according to various embodiments, SQL queries are synthesized based on a collection of different tables. Meanwhile, rather than crawling noisy tables from the Internet and subsequently applying heuristic filtering, clean tables may be taken directly from available public datasets. For example, tables from the WTQ training set may be randomly selected to serve as the table source for the SQL execution task.

According to one embodiment, a rehearsal strategy is used, where a small amount (e.g., 1%) of data in FLAN tasks is replayed during training. For example, the training starts from the weights of FLAN-T5 (i.e. the LM 300 is initialized from FLAN-T5), and, for example 600K natural language training data elements 304 from the FLAN task mixture 305, along with 200K examples from the corpus of synthetic tasks is used. Compared to multi-task fine-tuning from scratch, such kind of rehearsal strategy saves a lot of computation and allows reusing the well-trained FLAN-T5 weights.

It should be noted that multitasking fine-tuning is applicable to LMs in general, but not necessarily to LLMs, as the cost of fine-tuning can be high. Therefore, according to various embodiments, symbolic tasks are injected to LMs by means of synthetic demonstrations (e.g. instead of using the for fine-tuning), where the symbolic task is employed as part of the instruction to LMs.

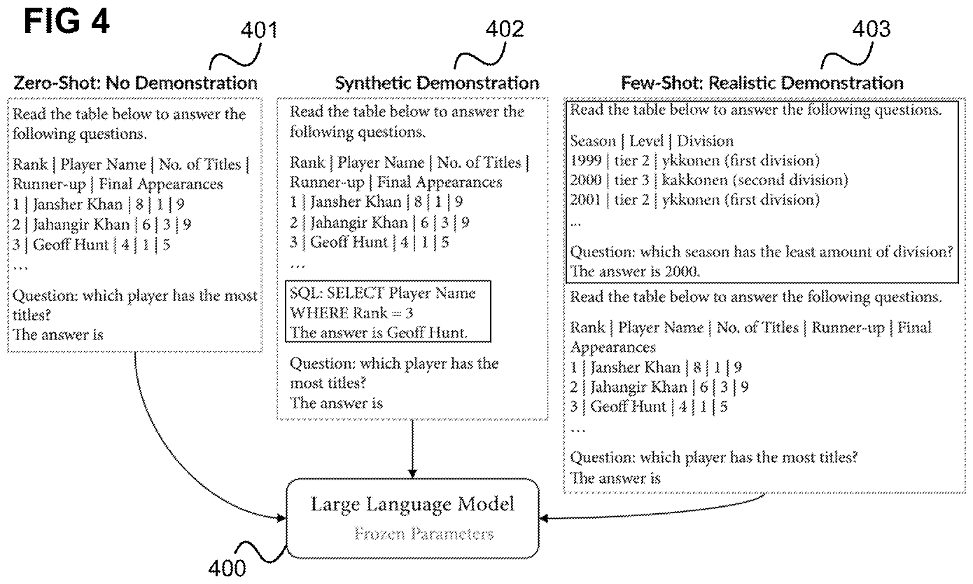

FIG. 4 illustrates different instruction strategies to prompt a large LM 400, including zero-shot 401, synthetic demonstration 402 and realistic demonstration 403.

In contrast to few-shot learning approaches, where the model parameters are updated based on few-shot demonstrations provided, the large LLM 400, when being used for inference or forward passes, may have frozen parameters which are not updated.

Under the zero-shot setting 401, the instruction to the model only contains the task description and the task input, without any demonstration, while the few-shot setting 403 introduces a few downstream examples as realistic demonstrations for the model to perform in-context learning.

Different from both of them, the SQL query and its execution result, i.e., the synthetic demonstration 402, can be leveraged as part of the instruction. The synthetic demonstrations can be flexibly synthesized without accessing realistic examples. In practice, it gives the flexibility to synthesize the corresponding SQL queries and obtain their execution results based on the task-related table.

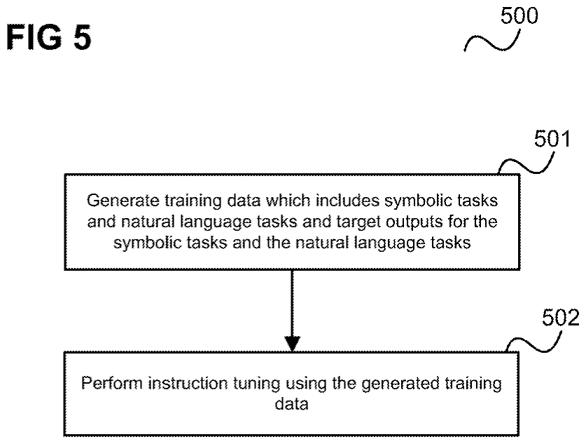

In summary, according to various embodiments, a method is provided as illustrated in FIG. 5.

FIG. 5 shows a flow diagram illustrating a method for training a language model (i.e. an AI (artificial intelligence) or ML (machine learning) language model).

In 501, training data is generated which includes symbolic tasks and natural language tasks and target outputs for the symbolic tasks and the natural language tasks.

In 502, instruction tuning (i.e. fine-tuning to follow instructions) of the language model using the generated training data is performed.

According to various embodiments, in other words, an approach for instruction tuning is used that leverages synthetic tasks to improve the performance of language models on unseen tasks.

The method of FIG. 5 is for example carried out by a data processing device, e.g. a computer 102 as illustrated in FIG. 1. The data processing device (e.g. computer 102) may for example include a communication interface (e.g. configured to receive data based on which it generates the training data, user prompts, etc.). The data processing device further includes a processing unit and a memory. The memory may be used by the processing unit to store, for example, data to be processed. The data processing device is configured to perform the method of FIG. 5.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed:

1. A method for training a language model, comprising:
generating training data, the training data including symbolic tasks and natural language tasks and target outputs associated with the symbolic tasks and the natural language tasks; and
preforming instruction tuning of a language model based on the training data.

2. The method of claim 1, wherein the training data further includes training inputs, wherein each of the training inputs includes a symbolic task and an instruction to perform the symbolic task or a natural language task and an instruction to perform the natural language task.

3. The method of claim 1, further comprising:
determining a loss between outputs of the language model and the target outputs associated with the natural language tasks; and
adapting parameters of the language model to reduce the loss.

4. The method of any one of claim 1, further comprising:
determining a loss between outputs of the language model and the target outputs for the symbolic tasks; and
adapting parameters of the language model to reduce the loss.

5. The method of claim 4, wherein the language model comprises a neural network and the parameters include neural network weights.

6. The method of any one of claim 1, wherein each of at least some of the symbolic tasks is a query in a database query language.

7. The method of claim 6, wherein the database query language is Structured Query Language.

8. The method of claim 1, further comprising:
training the language model based on a training data set that includes first training data elements, and second training data elements, wherein each of the first training data elements includes a specification of a respective symbolic task and a target output for the symbolic task and each of the second training data elements includes a specification of a respective natural language task and a target output for the natural language task.

9. The method of any one of claim 1, further comprising:
training the language model based on a training data set that includes the training data, wherein each training data element of the training data includes, as training input, a specification of a respective symbolic task, a target output for the symbolic task, a natural language task and a target output for the natural language task.

10. The method of claim 9, wherein the specification of the respective symbolic task includes a database table and the respective symbolic task is a query of the database table.

11. The method of any one of claim 1, wherein the language model is a large language model.

12. The method of any one of claim 1, wherein the language model is a pre-trained language model and wherein the method further comprises:
fine-tuning the pre-trained language model based on the generated training data.

13. A data processing system comprising:
a memory storing instructions; and
at least one processor coupled to the memory, the processor being configured to execute the instructions to:
generate training data, the training data including symbolic tasks and natural language tasks and target outputs associated with the symbolic tasks and the natural language tasks; and
preform instruction tuning of a language model based on the training data.

14. The data processing system of claim 13, wherein the training data further includes training inputs, wherein each of the training inputs includes a symbolic task and an instruction to perform the symbolic task or a natural language task and an instruction to perform the natural language task.

15. The data processing system of claim 13, wherein the at least one processor is further configured to execute the instructions to:
determine a loss between outputs of the language model and the target outputs associated with the natural language tasks; and
adapt parameters of the language model to reduce the loss.

16. The data processing system of claim 13, wherein the at least one processor is further configured to execute the instructions to:
determine a loss between outputs of the language model and the target outputs for the symbolic tasks; and
adapt parameters of the language model to reduce the loss.

17. The data processing system of claim 16, wherein the language model comprises a neural network and the parameters include neural network weights.

18. The data processing system of claim 13, wherein each of at least some of the symbolic tasks is a query in a database query language.

19. The data processing system of claim 18, wherein the database query language is Structured Query Language.

20. A non-transitory computer-readable medium comprising program instructions, which, when executed by one or more processors, cause the one or more processors to:
generate training data, the training data including symbolic tasks and natural language tasks and target outputs associated with the symbolic tasks and the natural language tasks; and
preform instruction tuning of a language model based on the training data.
